(19) United States
(12) Patent Application Publication
(10) Pub. No.: US 2006/0008258 A1
(43) Pub. Date: Jan. 12, 2006

(54) Device and method for reproducing compressed information

(75) Inventors: Kazushige Kawana, Saitama (JP); Akihiro Hashimoto, Sendai (JP); Kazuhiko Oogami, Saitama (JP); Hideyasu Iwano, Saitama (JP); Hiroyuki Enomoto, Saitama (JP); Shinichiro Abe, Saitama (JP); Hiroyuki Akama, Yamagata (JP); Masakazu Takahashi, Yamagata (JP)

Correspondence Address: FOLEY AND LARDNER LLP;SUITE 500, 3000 K STREET NW, WASHINGTON, DC, 20007, US

(73) Assignees: PIONEER CORPORATION; PIONEER SYSTEM TECHNOLOGIES CORPORATION; TOHOKU PIONEER CORPORATION

(21) Appl. No.: 11/138,316

(22) Filed: May 27, 2005

(30) Foreign Application Priority Data
May 31, 2004 (JP) 2004-161476

(51) Int. Cl. H04N 5/781

(52) U.S. Cl. 386/124; 386/125

(57) ABSTRACT

An information reproducing device includes a setting unit that sets priority for displaying appended data appended to compressed data in a compressed data file, such as an MP3 file. The appended data is appended at various positions to the compressed data. A reading unit reads a compressed data file, an extracting unit extracts appended data from the compressed data file based on the priority set, and a display unit displays the extracted appended data. A reproducing unit reproduces the compressed data.

### BACKGROUND OF THE INVENTION

1) Field of the Invention

The present invention relates to a technology for reproducing compressed data.

2) Description of the Related Art

The technology for compressing audiovisual data is advancing. The digital audiovisual data such as music and movies is large in volume so that it is generally compressed when recording in recording media. The compressed digital data is typically recorded in recording media such as optical recording media, magnetic optical recording media or magnetic recording media. Reproducing devices are used to decode the recorded digital data and to reproduce the data in a specific format. Examples of the optical recording media are compact discs (CD) and digital versatile discs or digital video discs (DVD). An example of the magnetic optical recording media is a mini disc (MD). An example of the magnetic recording media is a hard disk.

An example of the technology for compressing audio data is MPEG-1 Audio Layer 3 (MP3). MP3 compresses music data without much deteriorating the sound quality. The music data compressed with MP3 is recorded as MP3 files in, for example, CDs, and is reproduced by reproducing devices.

However, when a large number of MP3 files are recorded in a single recording medium, it is difficult for the user to determine the contents of each MP3 file from just the file name. To solve this problem so called ID3Tags are appended to the MP3 files. The ID3Tag is an area that stores textual information, such as titles of songs and names of artists, relating to the contents of an MP3 file. The textual information is displayed for the user when an MP3 file (song) is reproduced (played). As disclosed in Japanese Patent Application Laid Open No. 2003-141855, the MP3 files can include two types of ID3Tags: ID3TagVer1 and ID3TagVer2.

An audio reproducing device disclosed in Japanese Patent Application Laid Open No. 2002-245720 has an arrangement for designating whether an ID3Tag is to be read before reproducing an MP3 file. An MP3 file is reproduced without reading the ID3Tag if reading of the ID3Tag is not designated. As a result, the time required to start reproducing an MP3 file is reduced. In this case, however, because the ID3Tag is not read, it cannot be displayed for the user. Moreover, the audio reproducing device is previously set to prioritize either one of the two types of ID3Tags. Therefore, a user cannot arbitrarily select a desired type of ID3Tag for each MP3 file.

### SUMMARY OF THE INVENTION

It is an object of the present invention to provide an information reproducing device with which a user can select for displaying a desired type of appended data in a compressed data file.

According to an aspect of the present invention, an information reproducing device that reproduces a compressed data file, the compressed data file including compressed data and can include appended data, includes a setting unit that sets priority for displaying the appended data in the compressed data file; a reading unit that reads the compressed data file; an extracting unit that extracts the appended data from the compressed data file read based on the priority set; a display unit that displays the appended data extracted; and a reproducing unit that reproduces the compressed data in the compressed data file read.

According to another aspect of the present invention, an information reproducing device that reproduces a compressed data file, the compressed data file including compressed data and can include appended data, includes an input unit with which a user inputs instructions to display specific appended data in the compressed data file; a reading unit that reads the compressed data file; an extracting unit that extracts only the specific appended data from the compressed data file read; a display unit that displays the appended data extracted; and a reproducing unit that reproduces the compressed data in the compressed data file read.

According to still another aspect of the present invention, an image reproducing method of reproducing a compressed data file, the compressed data file including compressed data and can include appended data, includes setting priority for displaying appended data in the compressed data file; reading the compressed data file; extracting appended data from the compressed data file read based on the priority set; displaying the appended data extracted; and reproducing the compressed data in the compressed data file read.

According to still another aspect of the present invention, an image reproducing method of reproducing a compressed data file, the compressed data file including compressed data and can include appended data, includes receiving instructions from a user to display specific appended data in the compressed data file; reading the compressed data file; extracting only the specific appended data from the compressed data file read; displaying the appended data extracted; and reproducing the compressed data in the compressed data file read.

According to still other aspects of the present invention, a computer-readable recording medium stores therein a computer program that causes a computer to implement the above methods.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram for explaining the four types of compressed data files;

FIG. 2 is a schematic block diagram of an MP3 file reproducing device according to a first practical example of the present invention;

FIG. 3 is a flowchart of a processing procedure performed by the MP3 file reproducing device shown in FIG. 2; and

FIG. 4 is a schematic block diagram of an MP3 file reproducing device according to a second practical example of the present invention.

### DETAILED DESCRIPTION

Exemplary embodiments of the present invention will be described below with reference to accompanying drawings. The present invention is not limited to these embodiments or examples.

As explained in the explanation of the conventional technology, a compressed data file includes compressed data and appended data. Examples of the compressed data are music data and visual data. The appended data is information relating to contents of the compressed data, and is appended at a predetermined position to the compressed data. An information reproducing device according to the present invention reproduces the compressed data and displays the appended data.

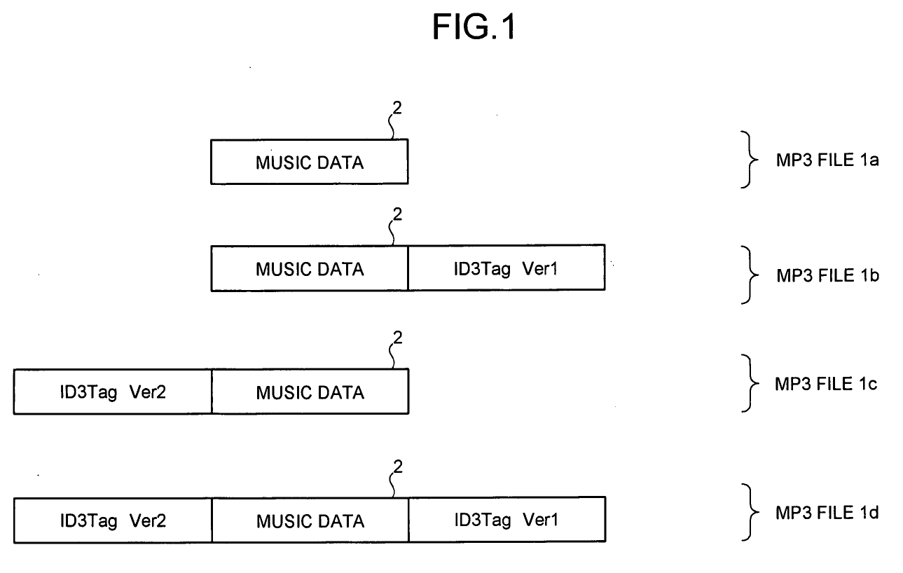

The appended data can be appended at the header or the footer of the compressed data. Thus, there can be four types of compressed data files 1a to 1d, as shown in FIG. 1. It is assumed here that the compressed data files are MP3 files, and the MP3 files include music data 2 as the compressed data and an IP3Tag as the appended data. When the appended data is appended at the header of the music data 2, it is called ID3Tag2, and when it is appended at the footer of the music data 2, it is called ID3Tag1.

The MP3 file 1a includes music data 2 without any appended data. The MP3 file 1b includes music data 2 with only ID3TagVer1 appended. The MP3 file 1c includes music data 2 with only ID3TagVer2 appended. The MP3 file 1d includes music data 2 with both ID3TagVer1 and ID3TagVer2 appended. Recording media such as CDs typically store a plurality of these MP3 files.

The information reproducing device decodes and displays appended data, appended at the header or at the footer, based on a predetermined setting set in the information reproducing device. Moreover, the information reproducing device decodes the compressed data and reproduces the decoded data. The appended data is displayed while the compressed data is being reproduced.

The appended data at the header and the appended data at the footer include different information. Therefore, a user might desire to display different appended data for each compressed data file. Furthermore, in each of the compressed data files, the appended data might be appended at different positions.

In view of these facts, the user can previously input a setting, so that the information reproducing device displays (prioritizes) either the appended data at the header or the appended data at the footer. Accordingly, the information reproducing device searches the appended data desired by the user, based on the setting.

The information reproducing device includes a switching section (setting unit) that determines which appended data to display, that is, whether to display the appended data that is appended at the header or appended at the footer. The user makes the setting in the switching section.

Thus, the user can arbitrarily select desired appended data to be displayed for each compressed data file, even when various types of compressed data files are included in a recording medium.

When no data is appended to the compressed data, there is no need to search appended data. In this case, a setting can be input in the switching section not to search appended data that does not exist. As a result, redundant processings are omitted, and the compressed data can be quickly reproduced.

Practical examples of the information reproducing device are explained below. An MP3 file, such as music data, is taken as an example of the compressed data file in the following practical examples; however, any other data can be used. The MP3 file includes music data as compressed data and ID3Tag as appended data. ID3TagVer1 is appended at the footer and ID3TagVer2 is appended at the footer of the music data. The ID3TagVer1 has a fixed length of 128 bytes.

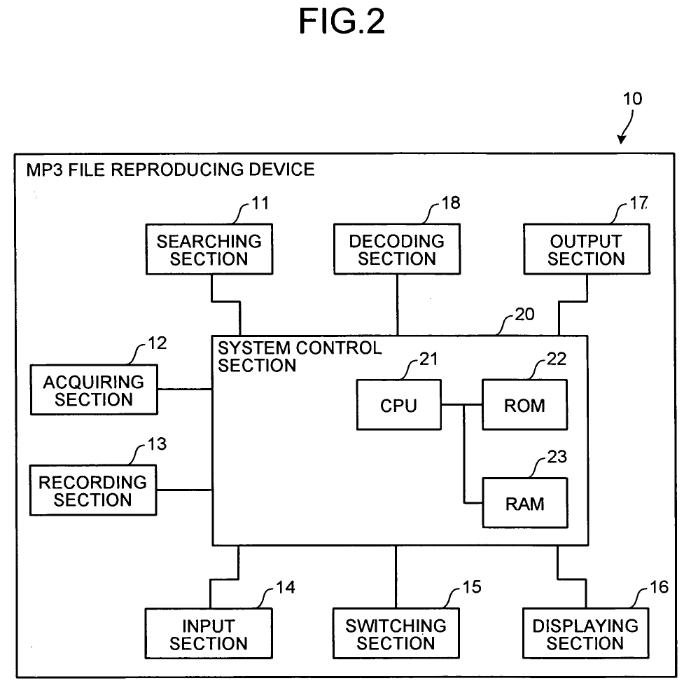

FIG. 2 is a schematic block diagram of an MP3 file reproducing device 10 according to a first practical example of the present invention. The MP3 file reproducing device 10 includes a searching section 11 that searches appended data, an acquiring section 12 that acquires the appended data, a recording section 13 that records music data, an input section 14 with which a user inputs a setting for acquiring the appended data, a switching section (setting unit) 15 that switches the setting, a displaying section 16 that displays the appended data for the user, an output section 17 that outputs music data etc., a decoding section 18 that decodes an MP3 file, and a system control section 20 that controls each of these sections.

The input section 14 includes an inputting unit (not shown), such as a keyboard and/or a mouse, with which the user can input data and/or instructions. The instructions are input to set priority for acquiring and displaying either ID3TagVer1 or ID3TagVer2 (hereinafter, “display setting”), or to reproduce a specific MP3 file. The recording section 13 reads music files form and/or writes music data in a recording medium (not shown). Examples of the recording medium are optical recording media such as CDs and DVDs, magnetic optical recording media such as MDs, or magnetic recording media such as hard disks.

The switching section 15 operates based on the instructions input by the user via the input section 14. In other words, the switching section 15 has an ID3Tag acquisition mode that can be turned on or off. When the ID3Tag acquisition mode is on, ID3TagVer1 or ID3TagVer2 is acquired from an MP3 file when the MP3 file is reproduced. For example, the display setting can be set such that when a prioritized ID3Tag cannot be acquired, the other (not prioritized) ID3Tag is acquired.

When an MP3 file is to be reproduced, the searching section 11 searches either ID3TagVer1 or ID3TagVer2 from the MP3 file based on the setting made in the switching section 15. The searching section 11 searches the footer of music data when searching ID3TagVer1, and searches the header of music data when searching ID3TagVer2. For example, the searching section 11 searches ID3TagVer1 or ID3TagVer2 based on the header address or the size of the MP3 file.

The acquiring section 12 acquires either ID3TagVer1 or ID3TagVer2 found by the searching section, and transmits the acquired ID3Tag to the decoding section 18. Appended data is thus extracted by the searching section 11 and the acquiring section 12. The decoding section 18 decodes music data and appended data acquired.

The displaying section 16 includes a displaying device (not shown), such as a liquid crystal display (LCD) or a cathode ray tube (CRT), and displays the extracted appended data. Precisely, the displaying section 16 displays character data (textual information) recorded in a data area of ID3TagVer1 or ID3TagVer2. Examples of the character data are titles of songs, names of artists, titles of albums, genres of songs, lyrics, images of album jackets, and so forth. The output section 17 performs digital-to-analog conversion and amplification processing on the decoded music data, and then outputs the music data as sound signals via a speaker (not shown) or the like.

The system control section 20 includes a central processing unit (CPU) 21, a read only memory (ROM) 22, and a random access memory (RAM) 23. The CPU 21 controls each of the sections in the MP3 file reproducing device 10, as follows. Based on input of a user received via the input section 14, the CPU 21 reads various control programs and application programs stored in the ROM 22. The CPU 21 then decompresses the programs in a program storing area in the RAM 23, and executes various processings. Various data generated by the processings are temporarily stored in a data storing area in the RAM 23. The system control section 20 executes an ID3Tag reading program, to read ID3Tags in MP3 files.

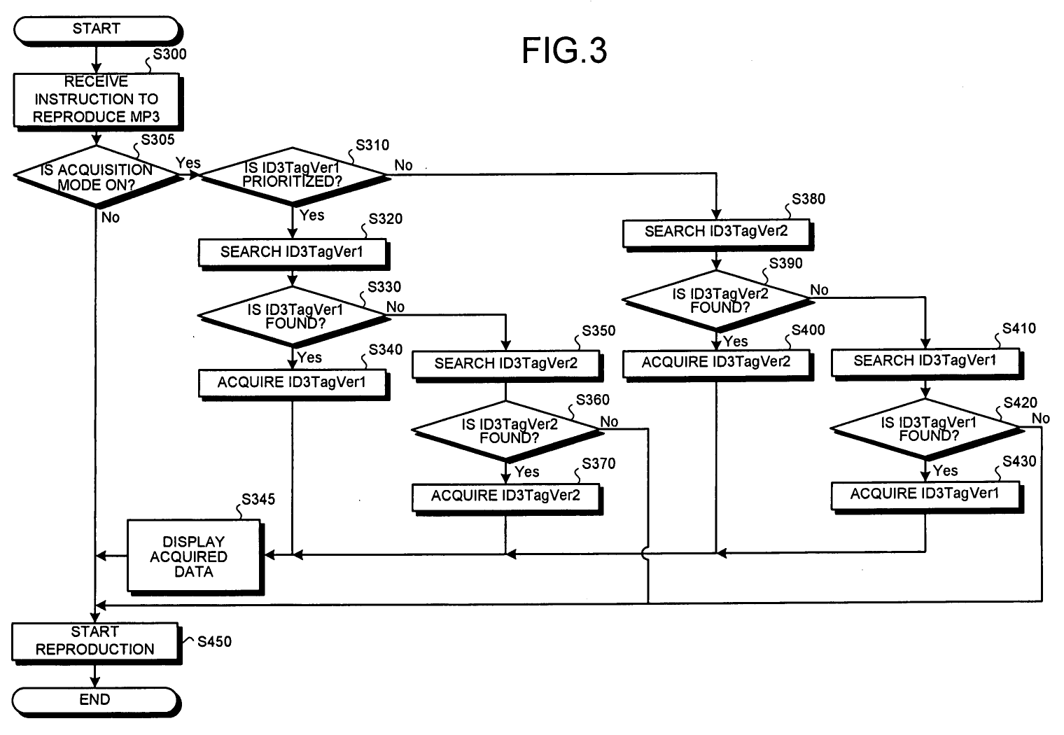

FIG. 3 is a flowchart of a processing procedure performed by the MP3 file reproducing device 10. The MP3 file reproducing device 10 previously receives an instruction from a user via the input section 14, whether to turn on the ID3Tag acquisition mode. The switching section 15 turns the ID3Tag acquisition mode on or off, according to the instruction.

The MP3 file reproducing device 10 receives an instruction from the user via the input section 14 to reproduce an MP3 file (step S300). When the instruction to reproduce the MP3 file is received, the system control section 20 confirms whether the ID3Tag acquisition mode is turned on at the switching section 15 (step S305).

When the system control section 20 determines that the ID3Tag acquisition mode is turned on (Yes at step S305), the system control section 20 confirms a display setting at the switching section 15 (step S310). At this point, the MP3 file reproducing device 10 receives an instruction to set the display setting (whether to prioritize ID3TagVer1 or ID3TagVer2) from the user via the input section 14. The instruction (the prioritized ID3Tag) is transmitted to the switching section 15, and the switching section 15 sets the display setting according to the instruction. When the system control section 20 determines that the ID3Tag acquisition mode is turned on at the switching section 15, a message can be displayed at the displaying section 16 to urge the user to input an instruction to set a display setting.

When the display setting set at the switching section 15 is to prioritize display of ID3TagVer1 (Yes at step S310), the system control section 20 searches an address of the MP3 file to be accessed in the recording medium, and searches for ID3TagVer1 (step S320). The searching section 11 searches the MP3 file for ID3TagVer1 (step S330).

When the MP3 file is structured like the MP3 file 1b or the MP3 file 1d shown in FIG. 1, the searching section 11 can find the prioritized ID3TagVer1 in the MP3 file. On the contrary, when the MP3 file is structured like the MP3 file 1a or the MP3 file 1c shown in FIG. 1, the searching section 11 cannot find the prioritized ID3TagVer1 in the MP3 file.

When the searching section 11 determines that ID3TagVer1 is found (Yes at step S330), the acquiring section 12 acquires ID3TagVer1 (step S340). The decoding section 18 decodes textual information recorded in a data area of ID3TagVer1. The decoded textual information is extracted and the displaying section 16 displays the extracted information (step S345).

On the other hand, when the searching section 11 determines that ID3TagVer1 is not found (No at step S330), the searching section 11 searches for ID3TagVer2, which is not prioritized at the switching section 15 (step S350). The searching section 11 searches the MP3 file to confirm whether ID3TagVer2 can be found (step S360).

When the MP3 file is structured like the MP3 file 1c shown in FIG. 1, the searching section 11 can find ID3TagVer2. When the MP3 file is structured like the MP3 file 1a shown in FIG. 1, the searching section 11 cannot find ID3TagVer2.

When the searching section 11 determines that ID3TagVer2 is found (Yes at step S360), the acquiring section 12 acquires ID3TagVer2 (step S370). The decoding section 18 decodes textual information recorded in a data area of the ID3TagVer2. The decoded textual information is extracted and the displaying section 16 displays the extracted information (step S345). On the other hand, when the searching section 11 determines that ID3TagVer2 is not found (No at step S360), the system control is given to step S450.

When the display setting set at the switching section 15 is to prioritize display of ID3TagVer2 (No at step S310), the system control section 20 searches an address of the MP3 file to be accessed in the recording medium, and searches for an ID3TagVer2 (step S380). The searching section 11 searches the MP3 file, and confirms whether ID3TagVer2 can be found (step S390).

When the MP3 file is structured like the MP3 file 1c or the MP3 file 1d shown in FIG. 1, the searching section 11 can find the prioritized ID3TagVer2 in the MP3 file. On the contrary, when the MP3 file is structured like the MP3 file 1a or the MP3 file 1b shown in FIG. 1, the searching section 11 cannot find the prioritized ID3TagVer2 in the MP3 file.

When the searching section 11 determines that ID3TagVer2 is found (Yes at step S390), the acquiring section 12 acquires ID3TagVer2 (step S400). The decoding section 18 decodes textual information recorded in a data area of ID3TagVer2. The decoded textual information is extracted and the displaying section 16 displays the extracted information (step S345).

On the other hand, when the searching section 11 determines that ID3TagVer2 is not found (No at step S390), the searching section 11 searches for ID3TagVer1, which is not prioritized at the switching section 15 (step S410). The searching section 11 searches the MP3 file, and confirms whether ID3TagVer1 can be found (step S420).

When the MP3 file is structured like the MP3 file 1b shown in FIG. 1, the searching section 11 can find ID3TagVer1. When the MP3 file is structured like the MP3 file 1a shown in FIG. 1, the searching section 11 cannot find ID3TagVer1.

When the searching section 11 determines that ID3TagVer1 is found (Yes at step S420), the acquiring section 12 acquires ID3TagVer1 (step S430). The decoding section 18 decodes textual information recorded in a data area of the ID3TagVer1. The decoded textual information is extracted and the displaying section 16 displays the extracted information (step S345). On the other hand, when the searching section 11 determines that ID3TagVer1 is not found (No at step S420), the system control is given to step S450. At step S450, the system control section 20 searches the header of the address of the MP3 file, and reproduces (plays) music data of the MP3 file (step S450).

When the system control section 20 determines that the ID3Tag acquisition mode at the switching section 15 is turned on, and when a display setting is already set at the switching section 15 at this point, ID3TagVer1 or ID3TagVer2 is acquired and displayed based on the display setting.

A display setting at the switching section 15 can be set for an entire album including a plurality of MP3 files, or for each MP3 file. When a display setting is changed while a song is being played, the change is applied from the next song. That is, the appended data displayed (ID3TagVer1 or ID3TagVer2) is switched from the next song.

In the present example, when ID3TagVer1 is not found, ID3TagVer2 is searched, and when ID3TagVer2 is not found, ID3TagVer1 is searched. However, when a user desires to display only either one of ID3TagVer1 or ID3TagVer2, the display setting can be set to search only the desired ID3Tag, and not to search the other one. Therefore, unnecessary searching can be omitted, even when the MP3 file includes both ID3TagVer1 and ID3TagVer2. Furthermore, the same setting can be applied when there are three types of ID3Tags appended to an MP3 file. In this case, when a user desires to display only one of the three ID3Tags, the display setting can be set to search only the desired ID3Tag, and not to search the other two ID3Tags. Therefore, unnecessary searching can be omitted.

According to the first practical example, the MP3 file reproducing device 10 includes the switching section 15, with which a user can prioritize or specify a desired ID3Tag to be extracted (searched and acquired). Therefore, even when a recording medium includes various types of MP3 files (MP3 files 1a to 1d as shown in FIG. 1), the desired ID3Tag can be displayed for each MP3 file.

Moreover, when it is already known that an MP3 file does not have an ID3Tag at either the header or the footer, the ID3Tag is not searched. In this case, a display setting can be set not to search an ID3Tag that does not exist. As a result, redundant processings are omitted, and the MP3 file can be quickly reproduced.

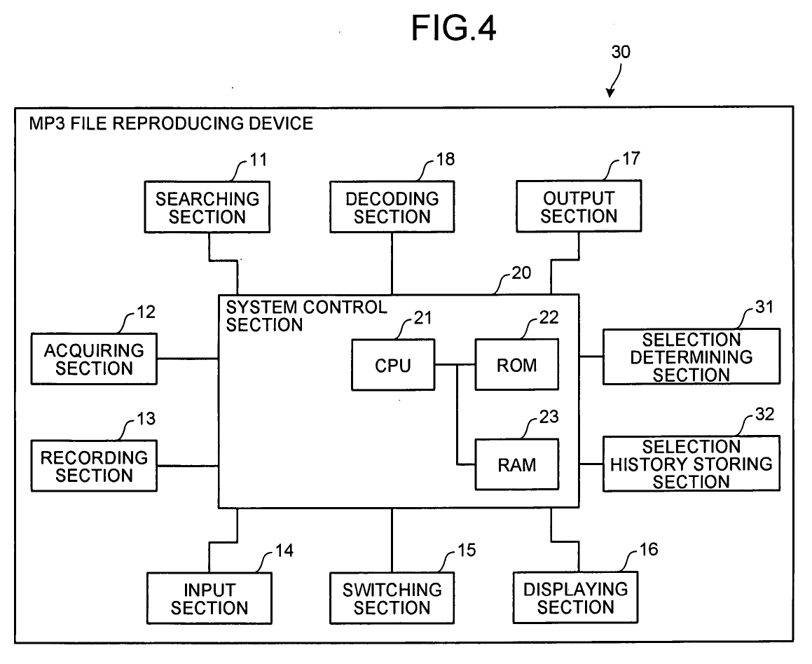

FIG. 4 is a schematic block diagram of an MP3 file reproducing device 30 according to a second practical example. The MP3 file reproducing device 30 according to the second practical example is almost the same as the MP3 file reproducing device 10 according to the first practical example shown in FIG. 2, except that a selection determining section 31 and a selection history storing section 32 are included. Common components are denoted by the same reference numerals and overlapping descriptions are omitted to avoid redundant explanation.

The selection history storing section 32 stores selection history. For example, each time an MP3 file is reproduced, the selection history storing section 32 stores a display setting selected by a user. In this case, the selection history corresponds to the number of times the user selects to prioritize ID3TagVer1 and ID3TagVer2.

The selection determining section 31 determines which ID3Tag is to be displayed for each MP3 file, based on the selection history stored in the selection history storing section 32, and a selection criterion. For example, when the number of times that either one of ID3TagVer1 or ID3TagVer2 is selected exceeds a predetermined number, the corresponding ID3Tag is prioritized for display (hereinafter, “priority ID3Tag”). Another selection criterion can be that when either one is selected more frequently than the other, the corresponding ID3Tag is the priority ID3Tag.

A processing performed by the MP3 file reproducing device 30 according to the second practical example is almost the same as that of the first practical example as described with reference to FIG. 3, except for the following.

Each time an MP3 file is reproduced, the selection history storing section 32 stores selection history, i.e., a display setting selected by a user. The selection determining section 31 previously receives a selection criterion from a user via the input section 14.

The selection determining section 31 determines a priority ID3Tag for each MP3 file based on the selection history and the selection criterion. The switching section 15 sets a display setting based on the determination of the selection determining section 31.

Subsequently, the same processing as the first practical example is performed, except that the MP3 file reproducing device 10 does not receive an instruction from the user at step S310, since the display setting is already set.

The display setting at the switching section 15 can be changed based on selection history stored while an album is being reproduced, instead of selection history for each MP3 file stored in the past. For example, when a user selects the same IP3Tag, for example ID3TagVer1, for a specific number of MP3 files in an album, all of the MP3 files in the album are automatically set to display only ID3TagVer1, without searching ID3TagVer2. Therefore, unnecessary searching can be omitted, and the desired appended data is quickly displayed.

The display setting at the switching section 15 can be set for each MP3 file, or for an entire album including a plurality of MP3 files. When the display setting is to be set for an album, the selection history storing section 32 stores a display setting for the album, each time the album is reproduced. A selection criterion for selecting either ID3TagVer1 or ID3TagVer2 is set for the album at the selection determining section 31. Accordingly, the selection determining section 31 determines the display setting for the album, based on the history of the display settings stored and the criterion set.

According to the second practical example, the selection determining section 31 automatically determines the type of appended data to be displayed for each MP3 file, based on history of display settings stored in the selection history storing section 32, and a predetermined criterion. Therefore, a user is not required to set a display setting every time an MP3 file is reproduced, so that the desired appended data is quickly displayed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information reproducing device that reproduces a compressed data file, the compressed data file including compressed data and can include appended data, comprising:
a setting unit that sets priority for displaying the appended data in the compressed data file;
a reading unit that reads the compressed data file;
an extracting unit that extracts the appended data from the compressed data file read based on the priority set;
a display unit that displays the appended data extracted; and
a reproducing unit that reproduces the compressed data in the compressed data file read.

2. The information reproducing device according to claim 1, further comprising an input unit with which a user inputs instructions to display appended data, wherein the setting unit sets the priority based on the instructions.

3. The information reproducing device according to claim 1, further comprising a selection history storing unit that stores history of appended data displayed for each compressed data file, wherein the setting unit sets priority for displaying appended data based on the history.

4. The information reproducing device according to claim 1, wherein appended data is appended to a header of compressed data or to a footer of compressed data.

5. The information reproducing device according to claim 1, wherein the compressed data file is music data compressed with MP3.

6. The information reproducing device according to claim 1, wherein appended data appended to a header of the compressed data is ID3TAGVer1, and appended data appended to a footer of the compressed data is ID3TAGVer2.

7. An information reproducing device that reproduces a compressed data file, the compressed data file including compressed data and can include appended data, comprising:
an input unit With which a user inputs instructions to display specific appended data in the compressed data file;
a reading unit that reads the compressed data file;
an extracting unit that extracts only the specific appended data from the compressed data file read;
a display unit that displays the appended data extracted; and
a reproducing unit that reproduces the compressed data in the compressed data file read.

8. The information reproducing device according to claim 7, wherein appended data is appended to a header of compressed data or to a footer of compressed data.

9. The information reproducing device according to claim 7, wherein the compressed data file is music data compressed with MP3.

10. The information reproducing device according to claim 7, wherein appended data appended to a header of the compressed data is ID3TAGVer1, and appended data appended to a footer of the compressed data is ID3TAGVer2.

11. An image reproducing method of reproducing a compressed data file, the compressed data file including compressed data and can include appended data, comprising:
setting priority for displaying appended data in the compressed data file;
reading the compressed data file;
extracting appended data from the compressed data file read based on the priority set;
displaying the appended data extracted; and
reproducing the compressed data in the compressed data file read.

12. An image reproducing method of reproducing a compressed data file, the compressed data file including compressed data and can include appended data, comprising:
receiving instructions from a user to display specific appended data in the compressed data file;
reading the compressed data file;
extracting only the specific appended data from the compressed data file read;
displaying the appended data extracted; and
reproducing the compressed data in the compressed data file read.

13. A computer-readable recording medium that stores therein a computer program that causes a computer to implement an image reproducing method of reproducing a compressed data file, the compressed data file including compressed data and can include appended data, the computer program causing the computer to execute:
setting priority for displaying appended data in the compressed data file;
reading the compressed data file;
extracting appended data from the compressed data file read based on the priority set;
displaying the appended data extracted; and
reproducing the compressed data in the compressed data file read.

14. A computer-readable recording medium that stores therein a computer program that causes a computer to implement an image reproducing method of reproducing a compressed data file, the compressed data file including compressed data and can include appended data, the computer program causing the computer to execute:
receiving instructions from a user to display specific appended data in the compressed data file;
reading the compressed data file;
extracting only the specific appended data from the compressed data file read;
displaying the appended data extracted; and
reproducing the compressed data in the compressed data file read.
